(19) United States
(12) Patent Application Publication
(10) Pub. No.: US 2026/0080244 A1
(43) Pub. Date: Mar. 19, 2026

(54) MACHINE LEARNING MODELS TO REDUCE ERRORS IN DOCUMENT EXTRACTION

(71) Applicant: Schlumberger Technology Corporation, Sugar Land, TX (US)

(72) Inventors: Omkar Anil Gune, Pune (IN); Prashanth Pillai, Pune (IN)

(21) Appl. No.: 19/303,820

(22) Filed: Aug. 19, 2025

(30) Foreign Application Priority Data
Sep. 13, 2024 (IN) 202411069445

(51) Int. Cl. G06N 3/08

(52) U.S. Cl. CPC G06N 3/08

(57) ABSTRACT

A method including extracting, by a machine learning model executing using an electronic document, data to create extracted data. An error checking controller is executed on the extracted data to identify erroneous data within the extracted data. A label for the erroneous data is generated by a label controller executing on the erroneous data. The label identifies a type of error of the erroneous data and a correction to the type of error. The label is added to the erroneous data to generate labeled erroneous data. A training controller executes iterative steps to train the machine learning model using the electronic document, the labeled erroneous data, and a first instruction to generate new extracted data. The trained machine learning model is returned. The trained machine learning model has a reduced data extraction error rate relative to the machine learning model prior to executing the training controller.

### CROSS-REFERENCE TO RELATED APPLICATIONS

This application claims priority to Indian provisional patent application 202411069445, filed Sep. 13, 2024, the entirety of which is hereby incorporated by reference in its entirety.

### BACKGROUND

Artificial Intelligence (AI) technologies such as deep learning machine learning models are used for automatic data ingestion into a computer system. Automatic extraction of visual entities, such as tables, forms, logs, and seismic data from documents can help in data ingestion and data segregation. While automatic ingestion can greatly reduce human efforts, any error in the extraction process can severely affect downstream applications.

### SUMMARY

One or more embodiments provide for a method. The method includes extracting, by a machine learning model executing using an electronic document, data to create extracted data. The method also includes executing an error checking controller on the extracted data to identify erroneous data within the extracted data. The method also includes generating, by a label controller executing on the erroneous data, a label for the erroneous data. The label identifies a type of error of the erroneous data and a correction to the type of error. The method also includes adding the label to the erroneous data to generate labeled erroneous data. The method also includes executing, iteratively, a training controller by executing steps to train the machine learning model. Iteratively executing includes executing the machine learning model on the electronic document, the labeled erroneous data, and a first instruction to generate new extracted data. The first instruction instructs the machine learning model to apply the correction to the type of error when extracting new extracted data from the electronic document. Iteratively executing also includes executing the error checking controller on the new extracted data to generate new erroneous data. Iteratively executing also includes executing the label controller on the new erroneous data to generate a new label for the new erroneous data. Iteratively executing also includes adding the new label to the new erroneous data to generate labeled erroneous data. Iteratively executing also includes iterating execution of the training controller until a stop criterion is satisfied. The method also includes return, after the stop criterion is satisfied, the machine learning model as a trained machine learning model having a reduced data extraction error rate relative to the machine learning model prior to executing the training controller.

One or more embodiments also provide for a system. The system includes a computer processor and a data repository in communication with the computer processor. The data repository stores an electronic document. The data repository also stores extracted data extracted from the electronic document. The data repository also stores erroneous data within the extracted data. The data repository also stores a label for the erroneous data. The label indicates a type of error of the erroneous data and a correction to the type of error. The data repository also stores labeled erroneous data. The system also includes a machine learning model executable by the computer processor using the electronic document to extract the extracted data. The system also includes an error checking controller executable by the computer processor on the extracted data to identify the erroneous data. The system also includes a label controller executable by the computer processor on the erroneous data to generate the label, and add the label to the erroneous data to generate the labeled erroneous data. The system also includes a training controller executable by the computer processor to perform iterative steps to train the machine learning model. The iterative steps include executing the machine learning model on the electronic document, the labeled erroneous data, and a first instruction to generate new extracted data. The first instruction instructs the machine learning model to apply the correction to the type of error when extracting new extracted data from the electronic document. The iterative steps also includes executing the error checking controller on the new extracted data to generate new erroneous data. The iterative steps also includes executing the label controller on the new erroneous data to generate a new label for the new erroneous data. The iterative steps also includes adding the new label to the new erroneous data to generate labeled erroneous data. The iterative steps also includes iterating execution of the training controller until a stop criterion is satisfied. After the stop criterion is satisfied, the machine learning model includes a trained machine learning model having a reduced data extraction error rate relative to the machine learning model prior to executing the training controller.

One or more embodiments provide for another method. The method includes extracting, by a machine learning model executing using an electronic document, data to create extracted data. The method also includes executing an error checking controller on the extracted data to identify erroneous data within the extracted data. The method also includes generating, by a label controller executing on the erroneous data, a number of labels for the erroneous data. The number of labels identifies a number of types of errors of the erroneous data and corrections to the number of types of errors. Executing the label controller further includes clustering the erroneous data into a number of clusters including the number of types of errors. Executing the label controller further includes sampling the number of clusters to identify a number of subsets of the number of clusters. Executing the label controller further includes presenting the number of clusters on a graphical user interface. Each of the number of clusters is separately highlighted on the graphical user interface. Executing the label controller further includes receiving, after presenting the number of clusters, the number of labels from a user device in communication with the graphical user interface. The method also includes adding the number of labels to the erroneous data to generate labeled erroneous data. The method also includes executing, iteratively, a training controller by executing steps to train the machine learning model. Iteratively executing includes executing the machine learning model on the electronic document, the labeled erroneous data, and a first instruction to generate new extracted data. The first instruction instructs the machine learning model to apply the corrections to the number of types of errors when extracting new extracted data from the electronic document. Iteratively executing also includes executing the error checking controller on the new extracted data to generate new erroneous data. Iteratively executing also includes executing the label controller on the new erroneous data to generate a new label for the new erroneous data. Iteratively executing also includes adding the new label to the new erroneous data to generate labeled erroneous data. Iteratively executing also includes iterating execution of the training controller until a stop condition is satisfied. The method also includes return, after the stop condition is satisfied, the machine learning model as a trained machine learning model having a reduced data extraction error rate relative to the machine learning model prior to executing the training controller.

Other aspects of one or more embodiments will be apparent from the following description and the appended claims.

### BRIEF DESCRIPTION OF DRAWINGS

FIG. 1.1 and FIG. 1.2 show a computing system, in accordance with one or more embodiments.

FIG. 2 shows a flowchart of a method for improving machine learning models to reduce errors in document extraction, in accordance with one or more embodiments.

FIG. 3.1 and FIG. 3.2 show an architecture for a method for improving machine learning models to reduce errors in document extraction, in accordance with one or more embodiments.

FIG. 4.1, FIG. 4.2, FIG. 4.3, FIG. 4.4, and FIG. 4.5 show an example of user interfaces displaying data extracted from electronic documents and further represent examples of a method for improving machine learning models to reduce errors in document extraction, in accordance with one or more embodiments.

FIG. 5.1 and FIG. 5.2 show a computing system, in accordance with one or more embodiments.

Like elements in the various figures are denoted by like reference numerals for consistency.

### DETAILED DESCRIPTION

One or more embodiments are directed to reducing errors during automated data extraction from the documents using one or more machine learning models. Specifically, one or more embodiments provide for an error detection and correction framework for these entities. One or more embodiments provide for a methodology to mitigate erroneous extractions using minimal user feedback for retraining the machine learning models in an active learning setup. One or more embodiments also provide for a pipeline for error detection and correction for unstructured multipage document extraction tasks based on minimal user intervention/feedback. The extraction tasks may be used to extract entities, such as tables, forms, logs, seismic data, or other such entities.

In an embodiment, an extraction machine learning model executes on a document to extract entities. Then, an error checking controller determines whether errors exist in the extracted entities. For example, the errors may be inconsistencies between the expected data and the type of entity or a discrepancy within the data extracted for the entity itself. Based on the error checking controller identifying the error, the extraction machine learning model is modified as part of training to extract data from the document. In an embodiment, the training may be performed at inference time using the same document from which the extraction machine learning model is extracting data.

Error detection refers to identifying the entities which are incorrectly extracted from a document. Accurate extraction refers to extracting the entities as is, e.g., table contents for rows and columns of the table. In the absence of ground truth during deployment/production, one or more embodiments provide for a test time data augmentation-based technique to identify errors in the extracted entities. For example, in the case of tables, erroneous extraction may result in the merging of two rows/columns, splitting of a row/column into more than one rows/columns, missing cell content, etc.

Error correction refers to correcting the incorrectly extracted entities. Error correction is carried out in an active learning setup where: 1) first label recommendation system is proposed to minimize the labeling effort of the user. Very few samples are recommended to users for labels by performing clustering on the erroneous detections. Furthermore, parts of the samples may be labeled. 2) The machine learning-based table extraction model is retrained using data augmentation on samples labeled in the first step. In addition, rather than table extraction, a general entity extraction model, also in the form of a deep learning model, may be retrained using the data augmentation on samples labeled in the first step.

One or more embodiments provide for flagging the low confidence data extraction. The error detection module can also be used to showcase the model confidence of extracted entities. For example, in the case of table extraction, error free extraction can be highlighted with green color showing high model confidence, and table data extraction with errors can be highlighted with red color showing low model confidence.

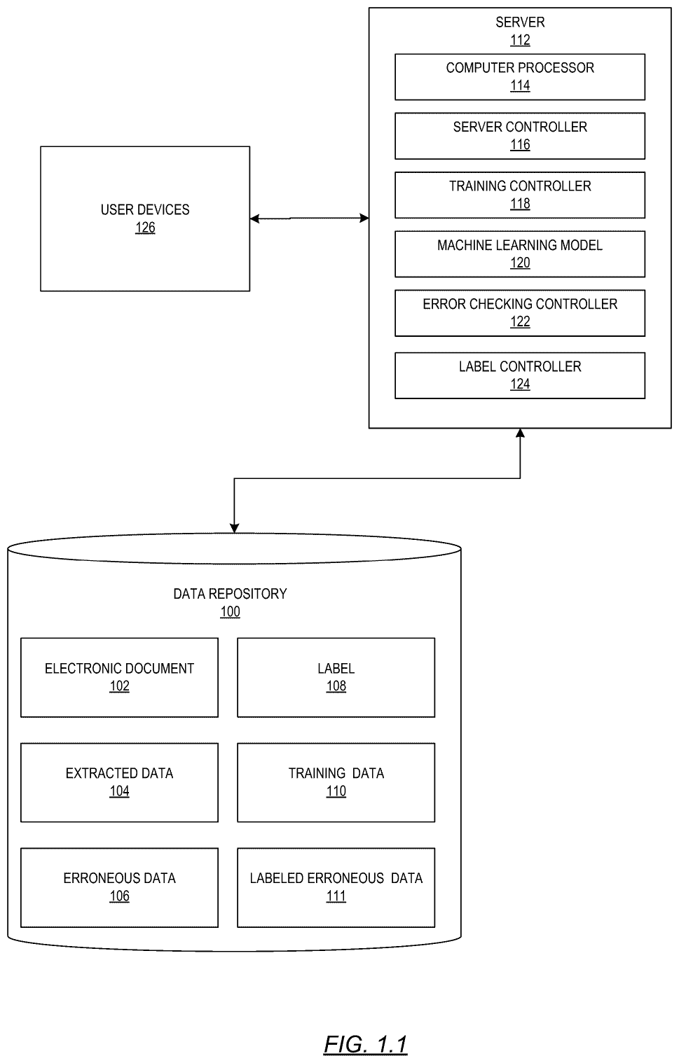

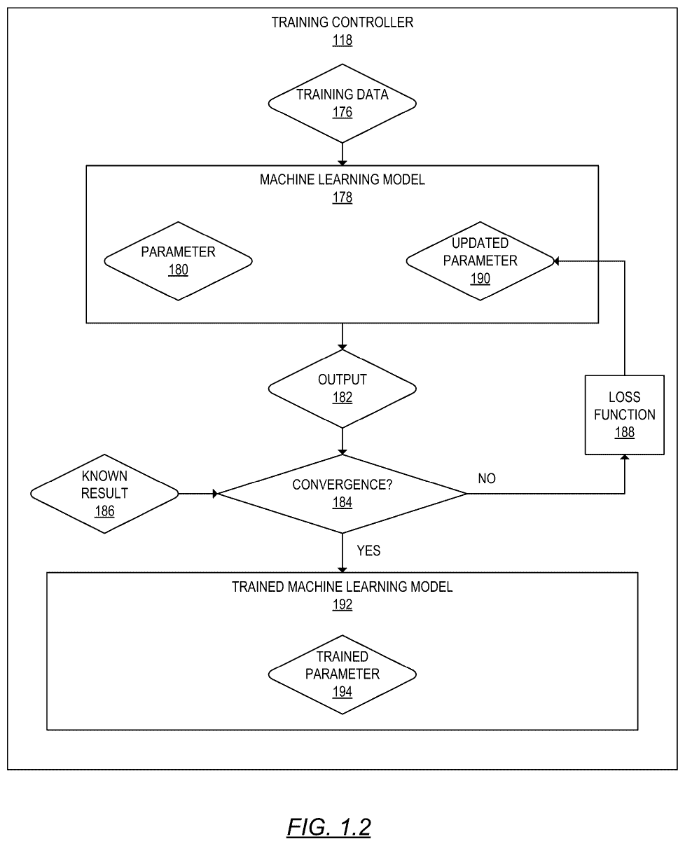

Attention is now turned to the figures. FIG. 1.1 shows a computing system, in accordance with one or more embodiments. The system shown in FIG. 1.1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores an electronic document (102). The electronic document (102) is data stored in a non-transitory computer readable storage medium which, when executed by a processor (e.g., a central processing unit or a graphics processing unit) may be rendered into a document displayed on a display device. Examples of the electronic document (102) may include data representing forms, tables, logs, seismic data, etc. Specific examples of the electronic document (102) may include portable document files (PDFs), word processing files, text files, etc.

The data repository (100) also stores extracted data (104). The extracted data (104) is data extracted from the electronic document (102). For example, a deep learning machine learning model (e.g., a convolutional neural network, a recurrent neural network, a transformer machine learning model, a language model, etc.) may be executed on the electronic document (102). The output of the deep learning machine learning model is the extracted data (104). The extracted data (104) may take the form of the tables, text, etc., of the electronic document stored in a different data structure format (e.g., a structured language document having key-value pairs, a text document from an original portable document format (PDF) document, etc.).

The data repository (100) also stores erroneous extracted data (106). The erroneous extracted data (106) is the extracted data (104), except that an error exists in the erroneous extracted data (106). The error results from the machine learning model failing to analyze the electronic document (102) properly. As a result, the machine learning model generates the errors. Examples of errors include combining rows or tables, splitting rows or tables, failing to insert values for keys, etc. as further exemplified below.

The data repository (100) also stores a label (108). The label (108) is metadata associated in one or more instances of the erroneous extracted data (106). The label (108) indicates whether the instance of the erroneous extracted data (106) is accurate or incorrect. The label (108) also may indicate the type of error (e.g., split columns, merged columns, missing data, etc.). The label (108) may be generated according to the techniques described below.

The data repository (100) also stores training data (110). The training data (110) is at least the erroneous extracted data (106) and the label (108). The training data (110) also may include other data, such as the electronic document (102), prior examples of electronic documents with associated extracted data, erroneous extracted data, and labels, etc.

The data repository (100) also stores labeled erroneous data (111). The labeled erroneous data (111) is the erroneous data (106) to which the label (108) or labels have been assigned. Because the labeled erroneous data (111) is part of any training dataset (i.e., the training data (110)), then the labeled erroneous data (111) may be considered a subset of the training data (110).

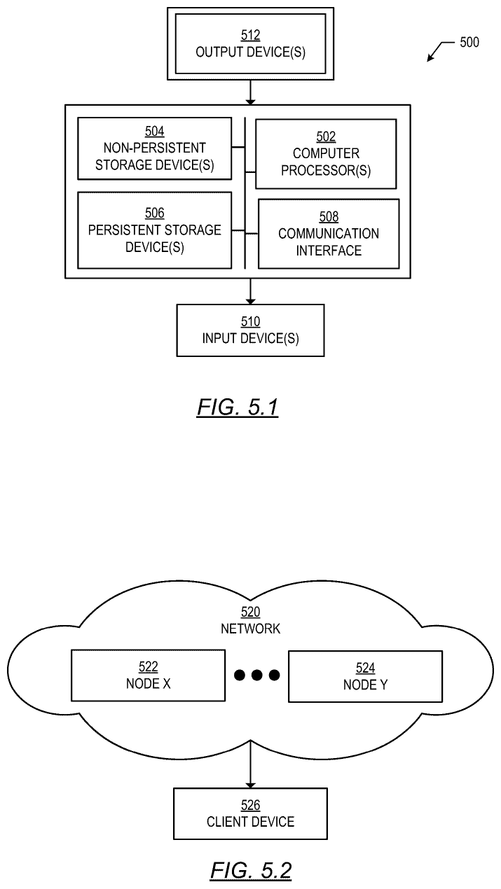

The system shown in FIG. 1.1 may include other components. For example, the system shown in FIG. 1.1 also may include a server (112). The server (112) is one or more computer processors, data repositories, communication devices, and supporting hardware and software. The server (112) may be in a distributed computing environment. The server (112) is configured to execute one or more applications, such as the server controller (116), training controller (118), machine learning model (120), error checking controller (122), and label controller (124). An example of a computer system and network that may form the server (112) is described with respect to FIG. 5.1 and FIG. 5.2.

The server (112) includes a computer processor (114). The computer processor (114) is one or more hardware or virtual processors which may execute computer readable program code that defines one or more applications, such as the language model (130), the vector generation controller (132), the mapping controller (134), or the training controller (118). An example of the computer processor (114) is described with respect to the computer processor(s) (502) of FIG. 5.1.

The server (112) also may include a server controller (116). The server controller (116) is software or application specific hardware which, when executed by the computer processor (114), controls and coordinates operation of the software or application specific hardware described herein. Thus, the server controller (116) may control and coordinate execution of the training controller (118), machine learning model (120), error checking controller (122), and label controller (124).

The server (112) also may include a training controller (118). The training controller (118) is software or application specific hardware which, when executed by the computer processor (114), trains one or more machine learning models shown in FIG. 1.1. The training controller (118) is described in more detail with respect to FIG. 1.2.

The server (112) also may include a machine learning model (120). The machine learning model (120) is used to extract the extracted data (104). The machine learning model (120) is a computer-executable algorithm expressed in computer-executable program code. The machine learning model (120) identifies hidden patterns in data upon which the machine learning model (120) is executed. Examples of the machine learning model (120) include a deep learning machine learning model (e.g., a convolutional neural network, a recurrent neural network, a transformer machine learning model, an optical character recognition model, a language model, etc.) which may be executed on the electronic document (102). The machine learning model (120) may be a neural network.

The neural network may operate using one or more layers of weights that may be sequentially applied to sets of input data, which may be referred to as input vectors. For each layer of a machine learning model, the weights of the layer may be multiplied by the input vector to generate a collection of products, which may then be summed to generate an output for the layer that may be fed, as input data, to a next layer within the machine learning model. The output of the machine learning model may be the output generated from the last layer within the machine learning model. Multiple machine learning models may operate sequentially or in parallel. The output may be a vector or scalar value. The layers within the machine learning model may be different and correspond to different types of models. As an example, the layers may include layers for recurrent neural networks, convolutional neural networks, transformer models, attention layers, perceptron models, etc. Perceptron models may include one or more fully connected (also referred to as linear) layers that may convert between the different dimensions used by the inputs and the outputs of a model. Different types of machine learning algorithms may be used, including regression, decision trees, random forests, support vector machines, clustering, classifiers, principal component analysis, gradient boosting, etc.

The machine learning models may be trained by inputting training data to a machine learning model to generate training outputs that are compared to expected outputs. For supervised training, the expected outputs may be labels associated with a given input. For unsupervised learning, the expected outputs may be previous outputs from the machine learning model. The difference between the training output and the expected output may be processed with a loss function to identify updates to the weights of the layers of the model. After training on a batch of inputs, the updates identified by the loss function may be applied to the machine learning model to generate a trained machine learning model. Different algorithms may be used to calculate and apply the updates to the machine learning model, including back propagation, gradient descent, etc.

The server (112) also may include an error checking controller (122). The error checking controller (122) is software or application specific hardware which, when executed by the computer processor (114), checks for errors in the extracted data (104). The error checking controller (122) is described further below.

The server (112) also may include a label controller (124). The label controller (124) is software or application specific hardware which, when executed by the computer processor (114), generates one or more labels (e.g., the label (108)) to be associated with one or more instances of the erroneous extracted data (106). The label controller (124) is described further below.

The system shown in FIG. 1 also may include one or more user devices (126). The user devices (126) are computing systems (e.g., the computing system (500) shown in FIG. 5.1) that communicate with the server (126).

The user devices (126) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

Attention is turned to FIG. 1.2, which shows the details of the training controller (118) mentioned with respect to FIG. 1.1. The training controller (118) is a training algorithm, implemented as software or application specific hardware, that may be used to train one or more of the machine learning models described with respect to the computing system of FIG. 1.1.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some pre-determined amount, or until some other termination condition occurs. After training, the final adjusted model is applied to unknown data (i.e., data for which the actual result is not known) in order to make predictions.

Some machine learning models may be applied to vector data structures. A vector is a computer readable data structure. A vector may take the form of a matrix, an array, a graph, or some other data structure. However, a frequently used vector form is a one by N matrix, where each cell of the matrix represents the value for one feature. As described above, a feature is a topic of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1.1 may be stored in the form of one or more vectors. For example, the electronic document (102), the extracted data (104), the erroneous extracted data (106), the training data (110), and the labeled erroneous data (111) may be expressed as vectors.

Returning to the operation of the training controller (118), training starts with training data (176), which may be expressed in vector form. The training data (176) may be the training data (110) from FIG. 1.1, or the labeled erroneous data (111) from FIG. 1, possibly expressed in vector form.

The training data may be labeled. The labels represent a known result. For example, the label may indicate that instances of the extracted data (104) of FIG. 1.1 are accurate or incorrect. Thus, the training data (176) may be data for which the final result is known with certainty.

More generally, the training data (176) is provided as input to the machine learning model (178), which may be the machine learning model (120) of FIG. 1.1. The machine learning model (178) may be characterized as a program that has adjustable parameters. The program is capable of learning and recognizing patterns to make predictions. The output of the machine learning model (178) may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model (178) being used (supervised versus unsupervised machine learning), or may be pre-determined by a user (e.g., convergence occurs after a set number of training iterations, described below).

In the case of supervised machine learning (e.g., the trained supervised machine learning model (144) of FIG. 1.1), the convergence process (184) compares the output (182) to a known result (186). The known result (186) is stored in the form of labels for the training data (176). For example, the known result (186) for a particular entry in an output (182) vector of the machine learning model (178) may be a known value, and that known value is a label that is associated with the training data (176).

Continuing the example of supervised machine learning model training, a determination is made whether the output (182) matches the known result (186) to a pre-determined degree. The pre-determined degree may be an exact match, a match to within a pre-specified percentage, or some other metric for evaluating how closely the output (182) matches the known result (186). Convergence may occur when the known result (186) matches the output (182) to within a pre-specified percentage. When many predictions are involved, then convergence may occur when more than a threshold number of predictions correctly match the corresponding labels.

For example, the threshold may be 95%. In this case, when the machine learning model (120) accuracy reaches 95% (representing that in 95 times out of 100 query predictions the machine learning model (120) correctly extracted data) then convergence occurs.

In the case of unsupervised machine learning, the convergence process (184) may be compared to the output (182) or to a prior output in order to determine a degree to which the current output changed relative to the immediately prior output or to the original output. Once the degree of change fails to satisfy the threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188). The program may be an algorithm which attempts to guess how the parameter (180) may be changed so that the next execution of the machine learning model (178), using the training data (176) with the updated parameter (190), will have an output (182) that is more likely to result in convergence. In this manner, the next execution of the machine learning model (178) is more likely to match the known result (186) (supervised learning), or which is more likely to result in an output (182) that more closely approximates the prior output (an unsupervised learning technique), or which otherwise is more likely to result in convergence.

In any case, the loss function (188) is used to specify the updated parameter (190). As indicated, the machine learning model (178) is executed again on the training data (176), this time with the updated parameter (190). The execution of the machine learning model process (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1.2 may be multiple parameters, weights, settings, etc.

During deployment, the trained machine learning model (192) with the trained parameter (194) is executed again, but this time on a new document. The output of the trained machine learning model (192) is extracted data for the new document.

While FIG. 1.1 and FIG. 1.2 shows a configuration of components, other configurations may be used without departing from the scope of one or more embodiments. For example, various components may be combined to create a single component. As another example, the functionality performed by a single component may be performed by two or more components.

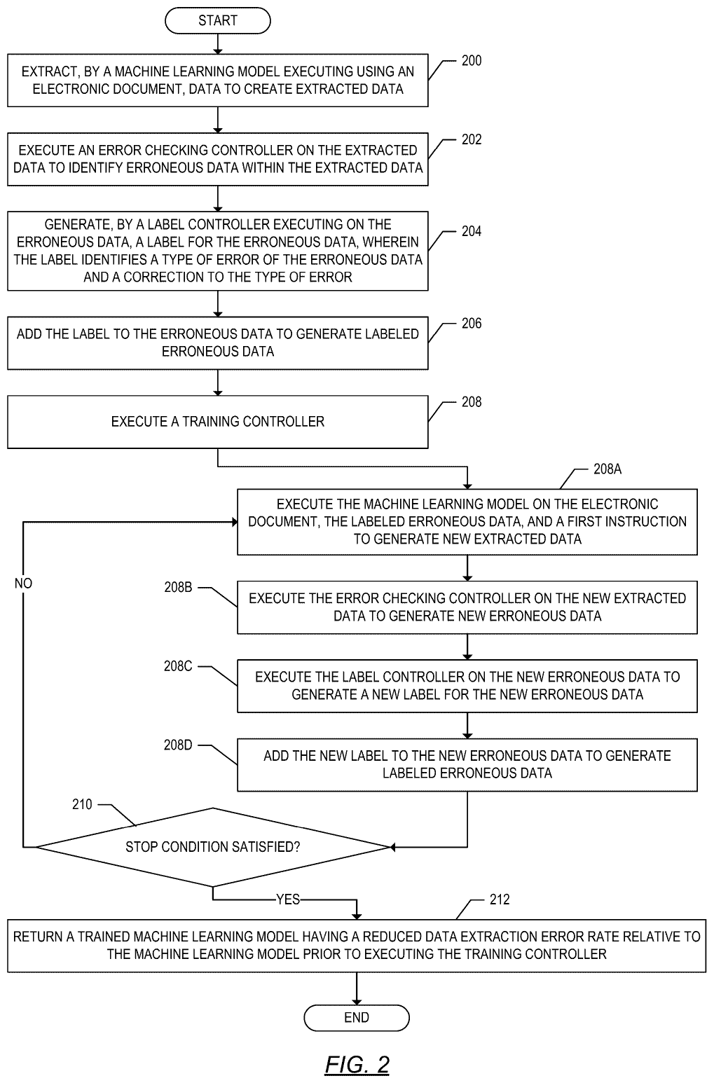

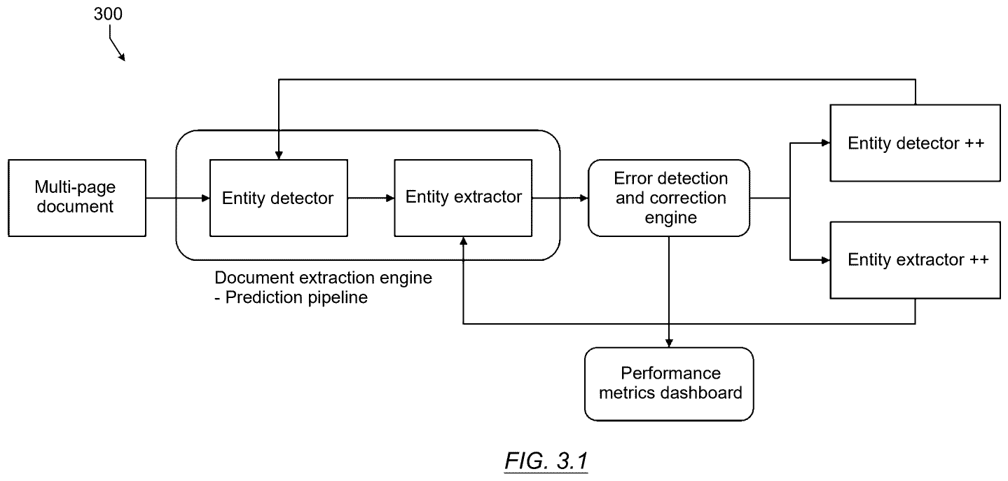

FIG. 2 shows a flowchart of a method for improving machine learning models to reduce errors in document extraction, in accordance with one or more embodiments. The method of FIG. 2 may be executed using the system shown in FIG. 1.1 and FIG. 1.2.

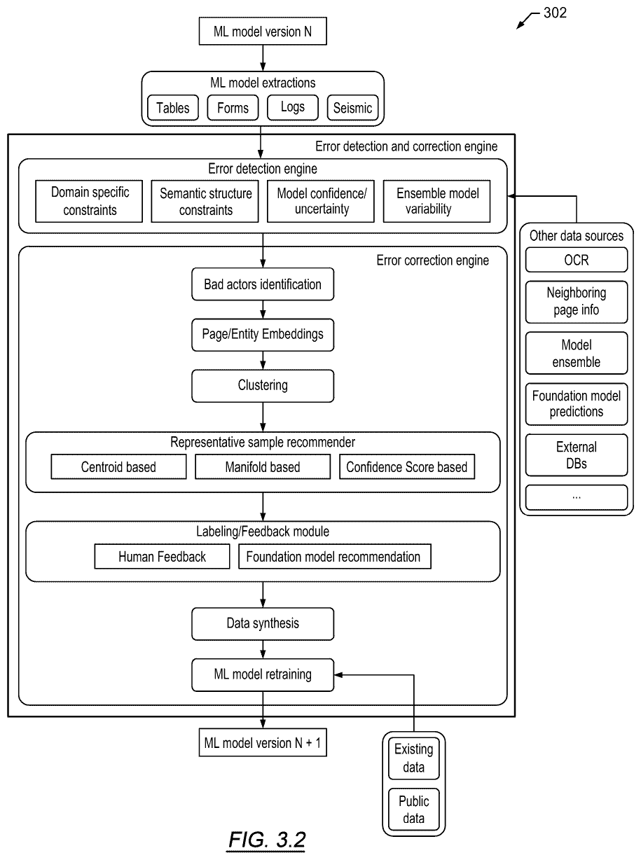

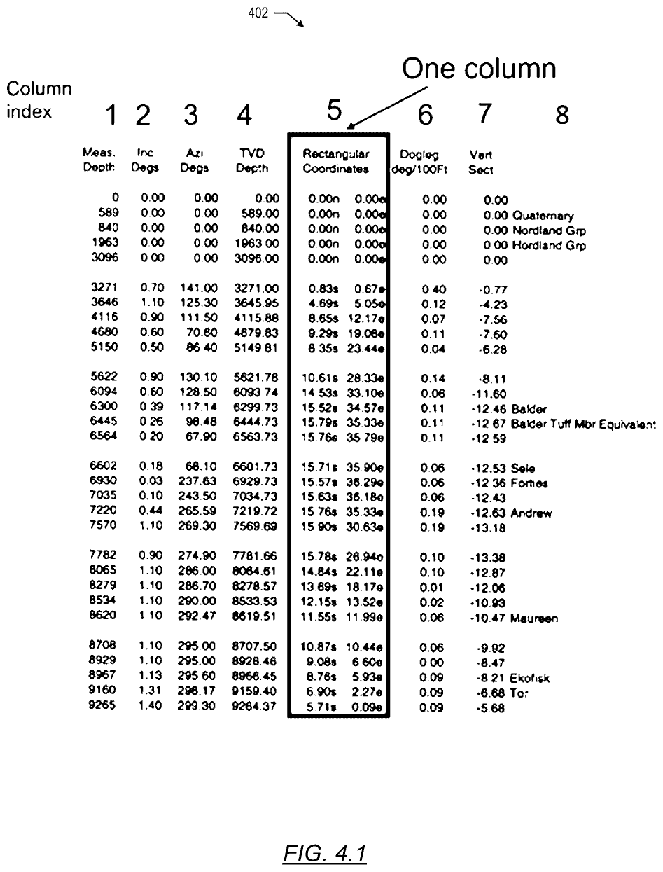

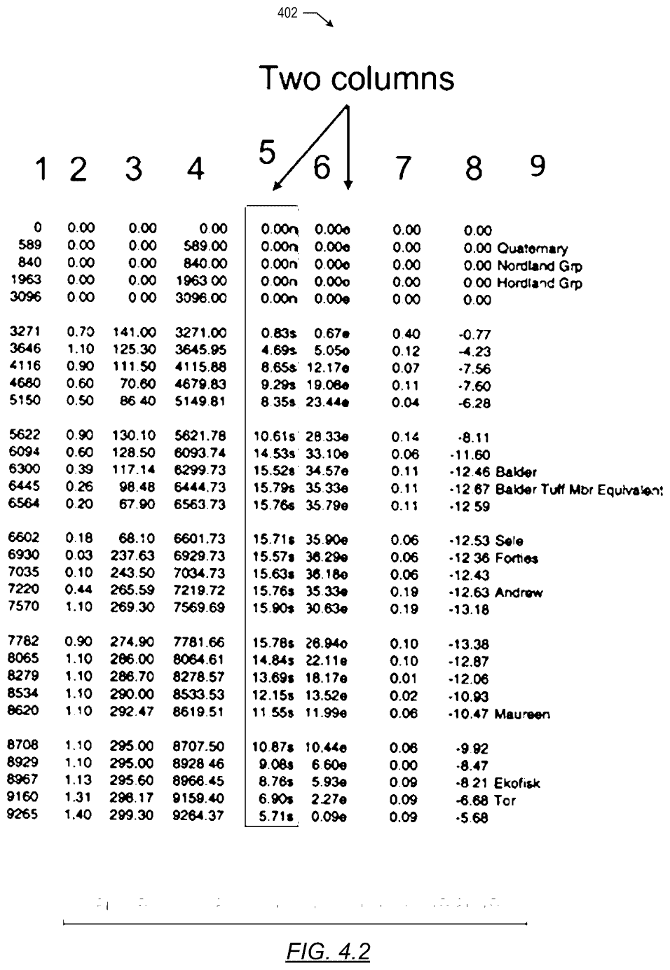

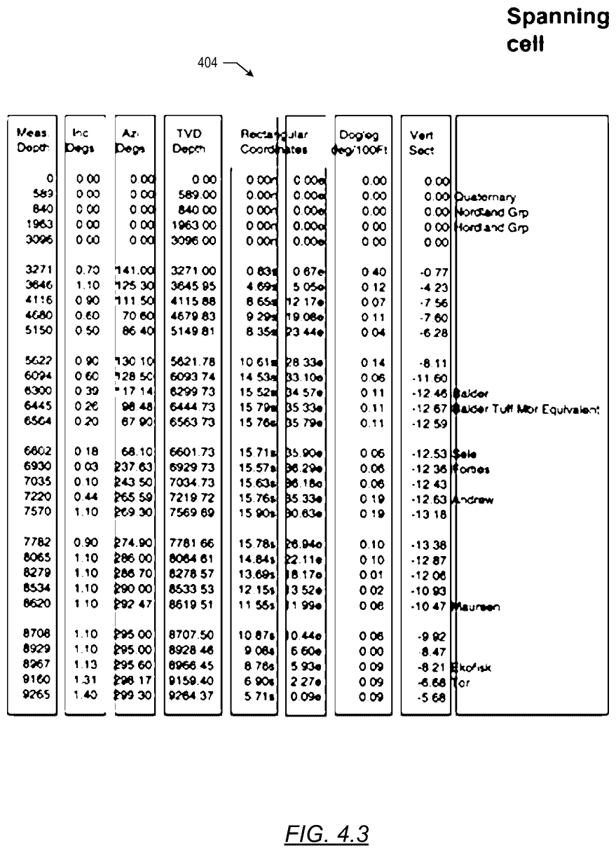

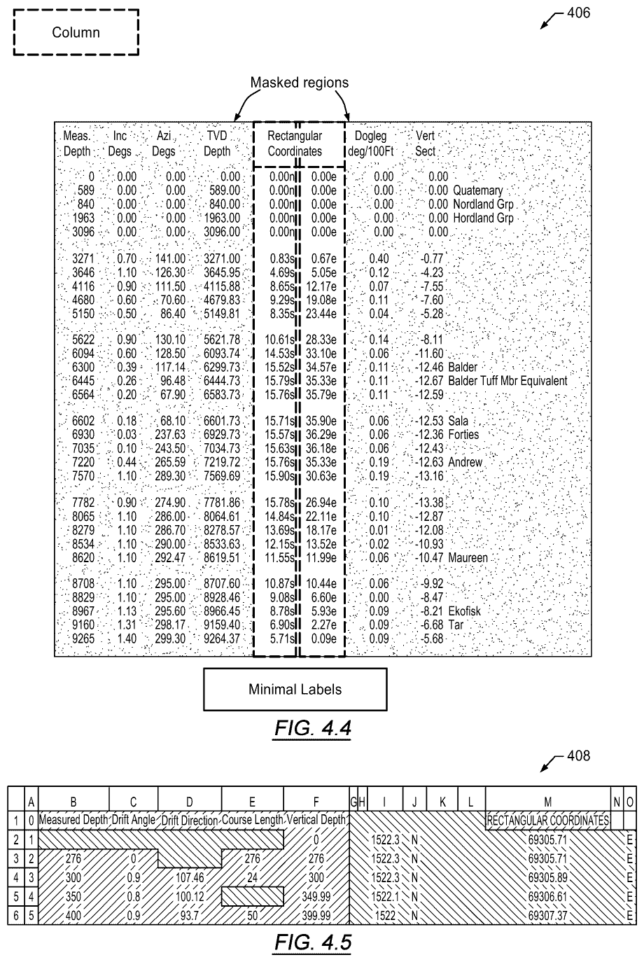

Step 200 includes extracting, by a machine learning model executing using an electronic document, data to create extracted data. Extraction may be performed according to a variety of different automated techniques. For example, optical character recognition may be performed on the electronic document to extract computer readable data storing alphanumeric characters, the arrangements of the characters, and other information in the document. In another embodiment, the machine learning model may be an extraction model, including a language model, that extracts columns, rows, and cell entries in a computer readable format (e.g., a delimited text file). Other types of data extraction techniques may include application programming interface (API) extraction, structured data extraction, entity extraction (for supervised learning machine learning models), clustering or topic modeling (for unsupervised machine learning models), and other data extraction techniques. Examples of data extraction are shown in FIG. 3.1 through FIG. 4.5.

Step 202 includes executing an error checking controller on the extracted data to identify erroneous data within the extracted data. The error checking controller is a type of software application or machine learning model that identifies error in data. The nature of the error checking controller may depend on the type of data that is being extracted. Generally, the error checking controller may perform, or iterate, one or more checks on the electronic document and then applies rules specifies in the error checking controller. If the error checking controller is one or more machine learning models, then the electronic document is input to the machine learning model (and possibly transformed into a vector first so that that the input is formatted for the machine learning model). A rules engine in the error checking controller may trigger the machine learning model in some ways.

For example, extracting may include executing an optical character recognition (OCR) application to the electronic document. The output of the OCR application is a number of bounding boxes around a number of rows in the electronic document. The OCR application may be rule-based software or a machine learning model. In the case of a machine learning model, the error checking controller may be a deep learning model. The deep learning model executes on the electronic document, together with the number of bounding boxes. The output of the deep learning model may include an error in the number of rows, the number of columns, the alignment of cells to columns or rows, etc. for the table.

In another embodiment, the electronic document includes a table having a number of columns having a number of headers. In an embodiment, executing the error checking controller includes executing a deep learning model on the number of columns with the number of headers to generate a first number of predicted columns output by the deep learning model. Executing the error checking controller also includes executing the deep learning model on the number of columns without the number of headers to generate a second number of predicted columns output by the deep learning model. Then, the error checking controller returns, responsive to the first number failing to match the second number, the erroneous data. The erroneous data relates to the first number of predicted columns and the second number of predicted columns.

In still another example, the electronic document includes a table having a number of cells. In this case, executing the error checking controller includes checking the number of cells for content. In the example, the error checking controller returns, responsive to the content missing in at least one of the number of cells, the erroneous data. The erroneous data relates to the content that is missing.

If some of the cells are deliberately left blank, then the missing data may be detected as being missing as follows. The contents cells in the electronic document may be detected by the extraction tool (deep learning model, OCR, etc.), as described above. However, the contents of the cells also may be detected by one or more additional methods (OCR, screen scraping, a deep learning model, etc.). The results of the two methods are compared against each other. If the results do not match, then an error is identified and the error checking controller may proceed as described above.

In still another example, the electronic document may include a table including a number of columns including at least one column name. In this case, executing the error checking controller includes identifying a predicted number of columns associated with the at least one column name. The error checking controller also detects a detected number of columns within the number of columns. Then, the error checking controller returns, responsive to the predicted number of columns failing to match the detected number of columns, the erroneous data. The erroneous data relates to the number of columns, meaning that the erroneous data may identify the mismatch in the number of columns in this example.

In yet another example, the electronic document may include a table that spans multiple pages. The table includes multiple columns that span the multiple pages. In this case, executing the error checking controller includes identifying the columns on one or more of the pages. One or more embodiments may identify a mismatch between columns on one page, or a mismatch between columns that should be the same from page to page but which change between pages due to an error. The error checking controller also detects a difference between the number of columns on the number of pages. The error checking controller returns, responsive to detecting the difference, the erroneous data. The erroneous data relates to the number of columns.

In still another example, the electronic document includes a number of key-value pairs. In this case, executing the error checking controller includes determining a type of value for the number of key-value pairs. The error checking controller also detects a difference in value type by comparing, for each of the number of key-value pairs, a corresponding value to the type of value. The error checking controller returns, responsive to detecting the difference, the erroneous data. The erroneous data relates to the number of key-value pairs.

Still other examples of the operation of the error checking controller are possible, depending on the nature of the electronic document and the types of errors to be detected. Accordingly, the examples described above do not necessarily limit other embodiments.

Step 204 includes generating, by a label controller executing on the erroneous data, a label for the erroneous data. The label identifies a type of error of the erroneous data and a correction to the type of error.

The label controller may cluster the erroneous data into a number of clusters. Each of the number of clusters represents a type of error. Thus, the number of clusters matches the number of types of errors, whereby a cluster exists for each type of error. Clustering may be performed using a clustering machine learning model or other clustering algorithm. The centroid of each cluster may be a pre-determined error type, or may be learned by a clustering machine learning model.

Then, the label controller may sample the clusters to identify a number of subsets of the clusters. Identifying subsets of the clusters reduces the number of errors to be processed, thereby increasing the computational efficiency of determining the nature of the label for a given type of error. Identifying subsets of the clusters also reduces the number of errors to be processed in the case that the errors are to be presented on a graphical user interface so that a human may input the labels. Thus, instead of labeling every single detected error, a few errors in each cluster of errors are labeled. The labels assigned to each subset then may be propagated automatically to the remaining errors detected in each cluster.

Thus, while the error detected at step 202 may include multiple errors distributed among the number of subsets, only one label per subset is generated. The remaining members of the cluster automatically are assigned the same label. Similarly, the label assigned at step 206 may include multiple labels associated with the errors, one label per cluster.

However, in another embodiment, each detected error may be assigned a separate label, either automatically by the error checking controller or by receiving labels from a user device. Other label generation processes are possible, such as by applying a classification machine learning model to the clusters of errors described above.

Step 206 includes adding the label to the erroneous data to generate labeled erroneous data. Adding the label may be performed by assigning the label as a metadata tag assigned to the erroneous data. Adding the label also may be performed by adding the label to a database which associates each set of erroneous data with an associated label. Other methods for adding the label to the erroneous data are possible.

Step 208 includes executing, iteratively, a training controller by executing steps to train the machine learning model. The training controller may be the training controller (118) of FIG. 1.1 and FIG. 1.2. Iteratively executing the training controller may include performing a number of sub-steps, as described below.

Sub-step 208A includes executing the machine learning model on the electronic document, the labeled erroneous data, and a first instruction to generate new extracted data. The first instruction instructs the machine learning model to apply the correction to the type of error when extracting new extracted data from the electronic document. Stated differently, step 200 is repeated, but this time the extraction model takes into account the erroneous data detected after the first pass of the extraction model. By taking into account the erroneous data, the extraction model is more likely to produce fewer errors, thereby improving the extraction model.

The extraction model may be a language model in one or more embodiments. In this case, sub-step 208A also may include inputting, as part of executing, another instruction (e.g., by way of a prompt) to the machine learning model that the generation of the erroneous data is to be avoided when extracting the new extracted data from the electronic document. Thus, again, the number of errors output by the extraction model may be reduced at each iteration of step 208.

Sub-step 208B includes executing the error checking controller on the new extracted data to generate new erroneous data. Sub-step 208B is similar to step 202. However, this time the error checking controller detects errors in the output (i.e., the new extracted data) of step 208A.

Sub-step 208C includes executing the label controller on the new erroneous data to generate a new label for the new erroneous data. Again, sub-step 208C is similar to step 204. However, this time the label controller generates and applies one or more labels to the output (i.e., the new erroneous data) of sub-step 208B.

Like step 206, sub-step 208B may include clustering, after executing the error checking controller on the new extracted data, a number of regions of the electronic document to generate a number of clusters. At least one of the number of clusters represents at least a portion of the new erroneous data. In this case, executing the label controller may include labeling only the portion of the new erroneous data. By using the clustering technique, the computational efficiency of performing the iterative process of step 208 may be increased.

Sub-step 208D includes adding the new label to the new erroneous data to generate labeled erroneous data. Again, sub-step 208D is similar to step 206. However, this time the new label is added to the output (i.e., the new erroneous data) of sub-step 208C.

Sub-step 210 includes iterating execution of the training controller until a stop criterion is satisfied. The stop condition may be that the number of new erroneous data detected at sub-step 208A is below a threshold number. The stop condition may be that the types of errors detected at sub-step 208C is below another threshold number. The stop condition may be a third number of iterations of the training controller execution at step 208. The stop condition may be some other stop condition.

If the stop condition is not satisfied (a “no” determination at step 210), then the process returns to sub-step 208A, and the iterative process continues. However, if the stop condition is satisfied (a “yes” determination at step 210), then the process continues to step 212).

Step 212 includes returning, after the stop criterion is satisfied, the machine learning model as a trained machine learning model having a reduced data extraction error rate relative to the machine learning model prior to executing the training controller. Returning may include storing the trained machine learning model for further use. Returning also may include deploying the trained machine learning model for use by users, such as by deploying the trained machine learning model in an enterprise environment or otherwise granting users access to the trained machine learning model.

The method of FIG. 2 may be further modified by adding, removing, or modifying one of the steps or sub-steps described above. For example, as mentioned above with respect to step 204, the method of FIG. 2 may include presenting the number of clusters on a graphical user interface. Each of the number of clusters may be separately highlighted on the graphical user interface. Thus, the user may easily see the types of errors.

After presenting the labels to the user, generating the label includes receiving, after presenting the number of clusters, the number of labels from a user device in communication with the graphical user interface. The labels apply to the clusters presented as highlighted groups of errors on the graphical user interface.

As an example, a first cluster of the number of clusters may include an error related to merging, or failing to merge, a number of columns or a number of rows. In this case, the first cluster is highlighted by a bounding box. The user may assign a label to the highlighted portion.

As another example, a first cluster of the number of clusters may include a missing cell entry error in a table. In this case, the first cluster is highlighted by coloring a cell corresponding to the missing cell entry error. Still other variations are possible.

The method of FIG. 2 may be expressed in a more general manner. In a more general embodiment, a first step includes executing a machine learning model on an electronic document to extract extracted data. The details of executing the machine learning model on the electronic document are described below.

A second step includes executing an error checking controller on the extracted data to generate erroneous extracted data. The details of executing the error checking controller are described below.

A third step includes executing a label controller on the erroneous extracted data to generate a label. The details of executing the label controller are described below.

A fourth step includes executing a training controller on training data to retrain the machine learning model. The training data includes the erroneous extracted data and the label. The label also may be used to correct the erroneous extraction. The correction or the corrected data may also be used as part of the training data. The details of executing the training controller are described with respect to FIG. 1.2, as further described below.

While the various steps in this flowchart are presented and described sequentially, at least some of the steps may be executed in different orders, may be combined or omitted, and at least some of the steps may be executed in parallel. Furthermore, the steps may be performed actively or passively.

FIG. 3.1 and FIG. 3.2 show an architecture for a method for improving machine learning models to reduce errors in document extraction, in accordance with one or more embodiments. The architecture shown in FIG. 3.1 and FIG. 3.2 are variations of the system shown in FIG. 1.1.

FIG. 3.1 shows the pipeline for the detection and extraction of entities from documents and updating the detector and extractor based on error detection and correction system output. One or more embodiments focus on the error detection and error correction for entities extracted from electronic documents. The entities may include tables, forms, logs, seismic data extracted from a multipage document, etc.

In particular, FIG. 3.1 shows a framework (300) for detecting the entities, extracting their contents, and using error detection and correction system to improve the detector and extractor. The entity detector refers to a module which detects entities, such as tables, forms, logs, seismic data, etc. The entity extractor refers to a module which extracts the actual contents of the entity (e.g., in the case of tables, entity extracts the contents of table), (i.e., rows, columns, and key-value pairs for forms).

Extracted entities are sent to error detection and correction system where automatic error detection and manual correction is carried out. Error detection and correction system outputs an improved detector and extractor model which can be used to replace the existing extractor engine. The error detection module can also be used to display the model confidence in the extracted data using a performance metrics dashboard. The details of error detection and correction system are shown in FIG. 3.2.

FIG. 3.2 shows a workflow (302) for error correction for entity extraction using an active learning setup. Extracted entities are first sent to the error detection module where errors are identified and located in the entities. Different errors in the extracted entities are identified and localized.

The localized erroneous extractions are clustered into similar looking errors. A sample recommender module is used to select a few samples per cluster for labeling. A foundation model is used to label the erroneous regions in the entity (e.g., table, forms, etc.). A data synthesis module generates labeled data which, along with existing data, is used to retrain and improve the entity extraction module.

One or more embodiments detects the incorrect extractions for entities, such as table, forms, logs, seismic data, etc. First, entities can be detected and extracted using deep learning machine learning models, such as a table transformer. For example, extracting table refers to identifying (bounding boxes of) rows, columns, and headers of a table. However, errors may be present. Examples of errors include, for tables, multiple rows are merged into one row. Another example error in an extracted table is multiple columns are merged into one column. Another example error in an extracted table is cell contents belonging to a row and column are missing. Another example error in an extracted table is a column being split into two or more columns. Another example error in an extracted table is an incorrect merging of multipage tables.

Different entities (documents, files, logs, forms, etc.) may include different error types. For example, for forms, the extracted entities may be missing a key, or a value, or both. For logs, the extracted entities may be missing a header or a plot segment.

For each of the above cases, the error detection module of one or more embodiments may use one or more of the techniques, such as domain specific context, semantic context, model uncertainty, and ensemble model-based assistance to perform error detection. Specific examples are now provided.

A first example of an error in an extracted document is multiple rows being merged into one row. One or more embodiments may identify such a case by using information from multiple sources including row bounding boxes identified by one or more techniques. For example, row bounding boxes may be created using optical character recognition (OCR). The coordinates of different text may correlate to identify that several different instances of text share a common axis. Then, a bounding box for a row can be obtained by processing the bounding boxes of contents in a row as detected by OCR.

In another example, row bounding boxes may be identified by a deep learning machine learning model. Based on the discrepancy in the number and locations of row bounding boxes, the error in row detection can be identified.

A second example of an error in an extracted document is multiple columns being merged into one column. One or more embodiments provide for a test time data augmentation technique to identify this error. Specifically, the output of the deep learning model in detecting column may depend on the alignment of a column name with column content. If both name and contents are aligned, the output of the deep learning model in detecting the bounding box for column would be the same in both the cases. In other words, a table with a header (column names) and a table the without header (column names) should have the same columns and values. If column name and the column's content are not aligned (e.g., column name is left justified and column contents are right justified), it may be possible that the outputs of the deep learning model in detecting column bounding box are different in the two cases.

Similarly, a table with a header and without a header may be perceived differently by a deep learning model if the table contains multiple columns grouped under one column. One or more embodiments may gauge the model confidence in extracting the table in two slightly altered samples originating from the same sample.

FIG. 4.1 and FIG. 4.2 shows an illustration for the error detection mechanism. FIG. 4.1 shows a table (400) containing a total of nine columns in which two columns (with id 5 and 6 in right side image) are erroneously grouped under one column name as rectangular coordinates.

In the test time data augmentation, first, table with header (column names) is passed through a deep learning model to obtain the bounding box predictions for the rows and columns (for simplicity, the examples focuses on column detection). The model returns eight columns where under column 5, two columns are grouped.

Second, one or more embodiments pass the same table without table header (column names) to the deep learning model to obtain column bounding boxes. The result is table (402) shown in FIG. 4.2. Table (402) shows that nine columns are detected, where columns 5 and 6 are treated as different columns.

The discrepancy is used in the number and the locations of columns detected in two separate passes as a measure for incorrect table extraction. The discrepancy in the number and location of columns results because of the fact that two samples (table with header and without header) may be perceived differently by deep learning model. On the other hand, if there is no discrepancy in the number and location of detected columns in two cases, the deep learning model is robust and confident in table extraction.

FIG. 4.1 and FIG. 4.2 also show that possible incorrect extraction of table can be flagged by identifying the number of columns detected in a table with header and table without headers. For the ease of understanding, the bounding boxes are shown for the column(s) where the deep learning model fails to identify the columns consistently in a table with and without header (bounding boxes for other columns and rows are not shown). If there is an inconsistency in the number of columns detected in the two cases, the columns may be merged or split. Accordingly, a possible extraction error has occurred, and such extracted data can be avoided during automated ingestion process.

The above technique may be used to address multiple columns being merged into one column. The above technique also may be applied to detect one column being split into multiple columns. While the fourth example, below, is also an error detection technique with respect to detecting errors in one column being split into multiple columns, the above technique also may be applied to the same type of error.

A third example of an error in an extracted document is cell contents are missing. The error can be identified by verifying if the cells in the extracted table have content. If cells in extracted table are void of content, then an error in table extraction may have occurred (a situation that could also be a limitation of OCR).

If cell contents are missing, a label may be provided to indicate whether the cell contents should be empty. For example, some cells intentionally may be left blank. Additionally, the error may be corrected using neighboring values to estimate the values of the missing cells.

A fourth example of an error in an extracted document is a column split into more than one column, as shown in table (404) of FIG. 4.3. The error can be identified by using domain knowledge of the column name. For example, a column of rectangular coordinates of the form N58 18 28.89, if split into multiple columns, can be identified using the knowledge of column name, column values, and an associated standard format of the column.

The error may be corrected by referring to the coordinates of the text and associating the various coordinates with a single header. The columns can then be merged under the header by referring to the locations of the text within the column. Additionally, a large language model may be used to predict whether the text at a column header is a column header to be relied upon in the above error correction scheme.

A fifth example of an error in an extracted document is incorrect merging of multipage tables. If the tables spanning on the multiple pages are merged incorrectly, the inconsistency across columns can be identified as follows. If a table spanning on multiple pages have different numbers of columns, the discrepancy identifies errors in table extraction. Machine learning assisted pattern matching for each column across multiple pages can be used to identify a discrepancy in merging multipage tables, such as depth varying linearly for depth column, etc.

A sixth example of an error in an extracted document is a missing key-value pair in an electronic form. If the extracted form has a missing key or value, the missing key or value can be detected. Based on domain knowledge, the correctness of value for a key can be established. For example, a valid extraction of a measurement of latitude in a form may be used to establish whether the extracted value is in the proper format for a latitude measurement.

FIG. 4.4 and FIG. 4.5 show an example of a method for improving machine learning models to reduce errors in document extraction, in accordance with one or more embodiments. FIG. 4.4 shows that clustering techniques may be used to cluster error types together into error classes, and then present a user with the classes of error for labeling. The masked regions in table (406) may be ignored by the user, and the white areas clearly designate which part of the form included the same type of error many times (i.e., the column values were split into two columns).

Once the erroneous extractions are identified, the error correction involves labeling the erroneous samples. As labeling the whole samples could be time consuming (e.g., labeling involves drawing bounding boxes for each row and column of table), one or more embodiments provide for an active learning-based novel strategy to minimize the labeling effort by labeling parts of samples and labeling a very few samples.

In the first step, tables are processed using an error detection module. The error detection module identifies and localizes the error in the table (e.g., certain rows and columns). For each extracted table, the erroneous portion of each sample is selected (instead of the full sample) to form a partial table image. Partial table images are clustered such that similar looking partial table regions are grouped into one cluster. Clustering using partial tables is better compared to clustering using complete tables as the partial table approach provides greater attention to the erroneously detected table regions.

Once the clusters are formed, sample recommender system is used to recommend few samples per cluster (subsets of the samples) for labeling. A sample may be recommended using the centroid of clusters, or manifold based distance of samples from the cluster centroid, or membership score of the samples for different clusters. A labeling module may be used to label such recommended (partial table) samples. Foundational models may also be used for the labeling purpose.

The subsets are highlighted on a graphical user interface, as shown in table (408) of FIG. 4.5. A user then may apply a label to each highlighted area (i.e., each cluster). The error checking controller can then propagate the label assigned in a cluster to each error detected in the table (408), if desirable to do so. In any case, the user (or an automated label generation controller) may efficiently generate a few labels, rather than labeling every error present in the table (408).

FIG. 4.3 and FIG. 4.4 show the labeling strategy where the user is requested to label the erroneous table regions. In FIG. 4.3, the labels (column and spanning cell bounding boxes are drawn for simplicity) are shown. In FIG. 4.4 the proposed labeling strategy is presented, where labels for few columns are requested from the user. The error detection module identifies the discrepancy in the location of the detected columns in table with a header and without a header. Thus, the user is focused on the columns whose bounding boxes differ using test time data augmentation. The part of the original table containing such columns is sent to the user for labeling while rest of the table is masked. The strategy can greatly reduce the labeling effort and speed up the retraining process. In general, in addition to the application of error checking and correction of tables, the techniques described above may be extended to forms, logs, and other forms of entities.

With partially labeled samples and existing labeled data, new table samples with labels may be generated using a labeled (synthetic) data generator to create large data for retraining of the deep learning model. The above active learning-based strategy to identify the samples or part of samples can be extended to other error scenarios as well. In other words, once labeled data (whether labels received as user input or automatically generated labels) is applied to the detected errors, the machine learning models (e.g., the deep learning model) may be retrained. The retrained model is less likely to exhibit the same type of errors. Thus, the machine learning model is improved.

In another example, a method known as “copy-paste data augmentation for instance segmentation” may be used to generate synthetic data. Other types of data augmentation techniques may be used to generate synthetic data to supply labels or missing data values.

FIG. 4.5 shows that an error detection module can also be used to graphically show the model confidence on the extracted data. For example, darker and lighter colors shows the model confidence on the correctly and incorrectly extracted data, respectively.

The error detection module can be used to visually display the model confidence of data extraction. Error free data extraction and error prone data extractions can be shown using red and green color, respectively, as shown in FIG. 4.5. The graphical user interface (GUI) in FIG. 4.5 allows users to easily identify the quality of extracted table data. Furthermore, a user can provide inputs based on the visualization for labeled data generation.

Thus, while machine learning techniques deliver robust performance in various tasks, including automatic data extraction from document, without one or more embodiments it is not clear if the output of models are acceptable due to lack of an error detection mechanism. One or more embodiments, however, gauge the deep learning model confidence in entity data extraction. The model confidence can help in identifying whether the model output is consumable or not.

One or more embodiments may be expanded from the examples above. For example, unanticipated types of errors may be discovered based on experimentation by using image processing models to compare an image of an original document to an image of a processed document. Unanticipated types of errors also may be discovered using open set recognition techniques. Differences in the images may reveal errors that occurred other than the categories given above, or errors of the above types that otherwise were not discovered.

One or more embodiments may be implemented on a computing system specifically designed to achieve an improved technological result. When implemented in a computing system, the features and elements of the disclosure provide a technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5.1, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN), such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5.1 may be connected to, or be a part of, a network. For example, as shown in FIG. 5.2, the network (520) may include multiple nodes (e.g., node X (522) and node Y (524), as well as extant intervening nodes between node X (522) and node Y (524)). Each node may correspond to a computing system, such as the computing system shown in FIG. 5.1, or a group of nodes combined may correspond to the computing system shown in FIG. 5.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5.1. Further, the client device (526) may include at least a portion of one or more embodiments.

The computing system of FIG. 5.1 may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited by the attached claims.

What is claimed is:

1. A method comprising:
extracting, by a machine learning model executing using an electronic document, data to create extracted data;
executing an error checking controller on the extracted data to identify erroneous data within the extracted data;
generating, by a label controller executing on the erroneous data, a label for the erroneous data, wherein the label identifies a type of error of the erroneous data and a correction to the type of error;
adding the label to the erroneous data to generate labeled erroneous data;
executing, iteratively, a training controller by executing steps to train the machine learning model, wherein iteratively executing comprises:
executing the machine learning model on the electronic document, the labeled erroneous data, and a first instruction to generate new extracted data, wherein the first instruction instructs the machine learning model to apply the correction to the type of error when extracting new extracted data from the electronic document,
executing the error checking controller on the new extracted data to generate new erroneous data,
executing the label controller on the new erroneous data to generate a new label for the new erroneous data,
adding the new label to the new erroneous data to generate labeled erroneous data, and
iterating execution of the training controller until a stop criterion is satisfied; and
return, after the stop criterion is satisfied, the machine learning model as a trained machine learning model having a reduced data extraction error rate relative to the machine learning model prior to executing the training controller.

2. The method of claim 1, wherein generating the label further comprises:
clustering the erroneous data into a plurality of clusters comprising a plurality of types of errors; and
sampling the plurality of clusters to identify a plurality of subsets of the plurality of clusters, wherein:
the error comprises a plurality of errors distributed among the plurality of subsets, and
the label comprises a plurality of labels associated with the plurality of errors.

3. The method of claim 2, further comprising:
presenting the plurality of clusters on a graphical user interface,
wherein generating the label comprises receiving, after presenting the plurality of clusters, the plurality of labels from a user device in communication with the graphical user interface.

4. The method of claim 3, wherein each of the plurality of clusters is separately highlighted on the graphical user interface.

5. The method of claim 4, wherein:
a first cluster of the plurality of clusters comprises an error related to merging, or failing to merge, a plurality of columns or a plurality of rows, and
the first cluster is highlighted by a bounding box.

6. The method of claim 4, wherein:
a first cluster of the plurality of clusters comprises a missing cell entry error in a table, and
the first cluster is highlighted by coloring a cell corresponding to the missing cell entry error.

7. The method of claim 1, wherein executing the error checking controller comprises:
executing an optical character recognition application to the electronic document to output a plurality of bounding boxes around a plurality of rows in the electronic document; and
executing a deep learning model on the electronic document together with the plurality of bounding boxes to output the error in the plurality of rows.

8. The method of claim 1, wherein the electronic document comprises a plurality of columns having a plurality of headers, and wherein executing the error checking controller comprises:
executing a deep learning model on the plurality of columns with the plurality of headers to generate a first number of predicted columns output by the deep learning model;
executing the deep learning model on the plurality of columns without the plurality of headers to generate a second number of predicted columns output by the deep learning model; and
returning, responsive to the first number failing to match the second number, the erroneous data, wherein the erroneous data relates to the first number of predicted columns and the second number of predicted columns.

9. The method of claim 1, wherein the electronic document comprises a plurality of cells, and wherein executing the error checking controller comprises:
checking the plurality of cells for content; and
returning, responsive to the content missing in at least one of the plurality of cells, the erroneous data, wherein the erroneous data relates to the content that is missing.

10. The method of claim 1, wherein the electronic document comprises a plurality of columns including at least one column name, and wherein executing the error checking controller comprises:
identifying a predicted number of columns associated with the at least one column name;
detecting a detected number of columns within the plurality of columns; and
returning, responsive to the predicted number of columns failing to match the detected number of columns, the erroneous data, wherein the erroneous data relates to the plurality of columns.

11. The method of claim 1, wherein the electronic document comprises a table that spans a plurality of pages, wherein the table comprises a plurality of columns that span the plurality of pages, and wherein executing the error checking controller comprises:
identifying a plurality of numbers of columns on the plurality of pages;
detecting a difference between the plurality of number of columns on the plurality of pages; and
returning, responsive to detecting the difference, the erroneous data, wherein the erroneous data relates to the plurality of columns.

12. The method of claim 1, wherein the electronic document comprises a plurality of key-value pairs, and wherein executing the error checking controller comprises:
determining a type of value for the plurality of key-value pairs;
detecting a difference in value type by comparing, for each of the plurality of key-value pairs, a corresponding value to the type of value; and
returning, responsive to detecting the difference, the erroneous data, wherein the erroneous data relates to the plurality of key-value pairs.

13. The method of claim 1, wherein executing the training controller further comprises:
inputting, as part of executing, a second instruction to the machine learning model that the generation of the erroneous data is to be avoided when extracting the new extracted data from the electronic document.

14. The method of claim 1, wherein executing the training controller further comprises:
clustering, after executing the error checking controller on the new extracted data, a plurality of regions of the electronic document to generate a plurality of clusters, wherein at least one of the plurality of clusters represents at least a portion of the new erroneous data,
wherein executing the label controller comprises labeling only the portion of the new erroneous data.

15. A system comprising:
a computer processor;
a data repository in communication with the computer processor and storing:
an electronic document,
extracted data extracted from the electronic document,
erroneous data within the extracted data,
a label for the erroneous data, wherein the label indicates a type of error of the erroneous data and a correction to the type of error, and
labeled erroneous data,
a machine learning model executable by the computer processor using the electronic document to extract the extracted data;
an error checking controller executable by the computer processor on the extracted data to identify the erroneous data;
a label controller executable by the computer processor on the erroneous data to: generate the label, and
add the label to the erroneous data to generate the labeled erroneous data; and
a training controller executable by the computer processor to perform iterative steps to train the machine learning model, the iterative steps comprising:
executing the machine learning model on the electronic document, the labeled erroneous data, and a first instruction to generate new extracted data, wherein the first instruction instructs the machine learning model to apply the correction to the type of error when extracting new extracted data from the electronic document,
executing the error checking controller on the new extracted data to generate new erroneous data,
executing the label controller on the new erroneous data to generate a new label for the new erroneous data,
adding the new label to the new erroneous data to generate labeled erroneous data, and
iterating execution of the training controller until a stop criterion is satisfied,
wherein, after the stop criterion is satisfied, the machine learning model comprises a trained machine learning model having a reduced data extraction error rate relative to the machine learning model prior to executing the training controller.

16. The system of claim 15, wherein the label controller is further executable to:
cluster the erroneous data into a plurality of clusters comprising a plurality of types of errors; and
sample the plurality of clusters to identify a plurality of subsets of the plurality of clusters, wherein:
the error comprises a plurality of errors distributed among the plurality of subsets, and
the label comprises a plurality of labels associated with the plurality of errors.

17. The system of claim 16, further comprising:
a graphical user interface in communication with the computer processor,
wherein the label controller is further executable to present the plurality of clusters on the graphical user interface, and
wherein executing the label controller comprises receiving, after presenting the plurality of clusters, the plurality of labels from a user device in communication with the graphical user interface.

18. The system of claim 17, wherein each of the plurality of clusters is separately highlighted on the graphical user interface.

19. The system of claim 18, wherein:
a first cluster of the plurality of clusters comprises an error related to merging, or failing to merge, a plurality of columns or a plurality of rows, wherein the first cluster is highlighted by a bounding box, and
a second cluster of the plurality of clusters comprises a missing cell entry error in a table, and wherein the second cluster is highlighted by coloring a cell corresponding to the missing cell entry error.

20. A method comprising:
extracting, by a machine learning model executing using an electronic document, data to create extracted data;
executing an error checking controller on the extracted data to identify erroneous data within the extracted data;
generating, by a label controller executing on the erroneous data, a plurality of labels for the erroneous data, wherein the plurality of labels identifies a plurality of types of a plurality of errors of the erroneous data and corrections to the plurality of types of errors, and wherein executing the label controller further comprises:
clustering the erroneous data into a plurality of clusters comprising the plurality of types of errors, and
sampling the plurality of clusters to identify a plurality of subsets of the plurality of clusters,
presenting the plurality of clusters on a graphical user interface, wherein each of the plurality of clusters is separately highlighted on the graphical user interface, and
receiving, after presenting the plurality of clusters, the plurality of labels from a user device in communication with the graphical user interface;
adding the plurality of labels to the erroneous data to generate labeled erroneous data;
executing, iteratively, a training controller by executing steps to train the machine learning model, wherein iteratively executing comprises:
executing the machine learning model on the electronic document, the labeled erroneous data, and a first instruction to generate new extracted data, wherein the first instruction instructs the machine learning model to apply the corrections to the plurality of types of errors when extracting new extracted data from the electronic document,
executing the error checking controller on the new extracted data to generate new erroneous data,
executing the label controller on the new erroneous data to generate a new label for the new erroneous data,
adding the new label to the new erroneous data to generate labeled erroneous data, and
iterating execution of the training controller until a stop condition is satisfied; and
return, after the stop condition is satisfied, the machine learning model as a trained machine learning model having a reduced data extraction error rate relative to the machine learning model prior to executing the training controller.
